(19) United States
(12) Patent Application Publication
(10) Pub. No.: US 2018/0287793 A1
(43) Pub. Date: Oct. 4, 2018

(54) RANDOM NUMBER GENERATION WITH UNSTABLE BIT STATES OF NON-VOLATILE MEMORY

(71) Applicant: INTEL CORPORATION, Santa Clara, CA (US)

(72) Inventors: Amirali KHATIB ZADEH, Hillsboro, OR (US); Shekoufeh QAWAMI, El Dorado HIlls, CA (US); Abhranil MAITI, Hillsboro, OR (US)

(21) Appl. No.: 15/476,739

(22) Filed: Mar. 31, 2017

(51) Int. Cl. H04L 9/08; G11C 13/00; G06F 12/14

(52) U.S. Cl. CPC H04L 9/0869; G11C 13/0004; G06F 12/1408; G11C 13/004; G11C 13/0069

(57) ABSTRACT

In one embodiment, an unpredictable nature of the storage properties in what is otherwise referred to as the “lockout period” following the programming of a non-volatile bitcell in a bitcell programming interval, is advantageously utilized in a random number generation mode to read random numbers from the memory. Accordingly, instead of locking out read operations in a lockout interval, a read operation may be performed in that or a similarly placed interval to read a bit state of the bitcell, which bit state is random in nature. The instability of the storage property varies from bitcell to bitcell and therefore may be used to generate a set of random bits from a block of bitcells. Other aspects are described herein.

### TECHNICAL FIELD

Certain embodiments of the present invention relate generally to random number generation devices using a non-volatile memory.

### BACKGROUND

A random number generator may be used to generate a random number for use in various algorithms such as cryptography algorithms. For example, one type of cryptographic algorithm is an encryption algorithm in which a random number may be used to specify the transformation of text into encrypted text. Similarly, in a decryption algorithm, the random number used as a key may be used to specify the transformation of encrypted text back into unencrypted text. Other types of cryptographic algorithms utilizing random numbers include message authentication codes to ensure authenticity. The cryptographic algorithm is frequently performed by a cryptographic engine which may utilize a generated random number as a seed for example, to generate additional numbers.

To effectively maintain privacy or reliable authentication, a random number for a cryptographic algorithm is preferably generated in a manner having both a high degree of randomness and a high degree of entropy which is a measure of uncertainty and is often related to the length of the random number. In general, the greater the degree of randomness and entropy with which a cryptographic random number is generated, the less likely that an unauthorized entity can guess the cryptographic key and obtain unauthorized access. Because cryptographic algorithms are frequently known or may be determined by analysis, it is often important to keep the cryptographic seed as private as possible.

Accordingly, generating a stream consisting of fully unpredictable and unbiased bits can play a significant role for security of the algorithms used in cryptographic applications, such as encryption and authentication, for example. Previously, random bits of the random number were generated off chip with an external entropy source and then were stored in an on-chip memory of an integrated circuit which includes the cryptographic engine. Accordingly, provisions were frequently made to ensure security of random numbers, particularly if the random number generation was performed in a third party facility.

However, on-chip storage of a random number may not be completely secure, particularly for applications with an extended life-cycle. For example, a stored random number may in some circumstances be compromised using advanced attack techniques such as probing.

An alternative approach for generating a random bit stream uses an on-chip Random Number Generator (RNG). On-chip RNG allows constant harvesting of random numbers such that generating a random bit stream becomes an on-chip feature, and is available when there is a need. Conventional on-chip RNGs have been designed employing analog circuitries such as ring oscillators. However, such devices can consume significant power and silicon area of the integrated circuit chip. Moreover, analog circuits typically have a very limited tolerance to process variations introduced during the fabrication of Integrated Circuits (ICs).

In recent years, non-deterministic physical characteristics of semiconductors have been proposed as a source of randomness or a pool of entropy or both. Nevertheless, the cost of generating a random bit stream has generally remained high particularly for resource-constrained applications such as battery operating system, or low-cost devices which typically have a reduced silicon footprint.

Random number generation may also be provided by a physically unclonable function (PUF) device in which the random number may be determined by physical differences resulting from unpredictable variations encountered in the manufacture of the device. These unpredictable manufacturing process variations can provide a degree of randomness to the random number generation. Moreover, these physical differences are often altered by unauthorized attempts to disassemble or otherwise reverse engineer the PUF device. Hence, the numbers generated by PUF devices may be both random and tamper resistant.

A number of different types of integrated circuits have been proposed for use as PUF devices. These prior proposals include use of logic circuitry including Arbiter PUF devices, Butterfly PUF devices, Ring Oscillator PUF devices, and coating PUF devices and use of memory element PUF devices including SRAM (Static Random Access) PUF devices, STT (Spin Transfer Torque) MRAM (Magnetic Random Access Memory) PUF devices, Re (Resistive) RAM PUF devices, Memorister PUF devices and DRAM (Dynamic Random Access Memory) PUF devices. However, the circuitry of these prior proposals has frequently exhibited one or more drawbacks such as being relatively complex, unreliable, large in size or a combination thereof.

A dynamic random access memory (DRAM) has a bitcell for storing charge to represent a bit as either a logical one or a logical zero. In an on state, a switching transistor connects a bitcell capacitor to read/write circuitry which can read the charge level stored on the capacitor and hence read the bit value stored in the bitcell. The cell switch transistor also connects the bitcell capacitor to read/write circuitry which can store charge on the bitcell capacitor at a level which “writes” a bit value into the bitcell.

However, even in the off state of the cell switch transistor, the charge stored on the storage capacitor of the DRAM bitcell tends to leak from the bitcell such that the stored charge level tends to decay over time. If the bitcell is not read or otherwise refreshed before the charge level decays to a certain degree, such charge level decay can cause data loss and errors in reading the bit values stored in the bitcells.

In one DRAM PUF device proposal, an initial pattern of data is written into bitcells of the memory and the resultant charge levels are intentionally permitted to decay to produce a modified pattern of data. The content of the modified pattern is a function of the initial pattern written to the memory and random structural differences between bitcells which resulted from random variations in the fabrication processes. The random structural differences are intended to affect the manner in which the charges decay to produce the modified pattern which is intended to be random.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating selected aspects of a system employing random number generation with unstable bit states of non-volatile memory in accordance with an embodiment of the present disclosure.

FIG. 2 depicts an example of a non-volatile memory and memory controller, employing random number generation with unstable bit states of non-volatile memory in accordance with an embodiment of the present disclosure.

FIGS. 3A, 3B each show an example of a non-volatile bitcell of the memory of FIG. 2 in greater detail.

FIG. 4 shows an example of a bitcell of the memory FIG. 2 together with read/write amplifier circuitry.

FIG. 5 is a timing diagram depicting one example of programming, and read operations in a read/write data storage mode of the memory and memory controller of FIG. 2.

FIG. 6 is a timing diagram depicting one example of programming and random bit state read operations in a random number generation mode of the memory and memory controller of FIG. 2.

FIG. 7 is a graphical illustration of a probability distribution of voltages in accordance with an embodiment of the present description.

FIG. 8 depicts an embodiment of a random number generation mode logic of the memory controller of FIG. 2.

FIG. 9 depicts an example of operations of the memory controller of FIG. 2 in a random number generation mode.

FIG. 10 is a block diagram illustration of one or more memory bitcells in accordance with an embodiment of the present disclosure.

### DESCRIPTION OF EMBODIMENTS

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

Non-volatile memory may utilize a bit state storage material to store a bit state in a bitcell as a function of a changeable storage property of the storage material. For example, a phase change memory may store a bit state in a bit cell by changing the phase of the storage material to either a crystalline phase to represent one bit state or to an amorphous phase to represent a different bit state. Phase change memory is a type of bulk property memory. A bulk property change memory such as a crosspoint memory, may store a bit state in a bit cell by changing a bulk property of a storage material to represent a particular state. The non-volatile memory of the present description may be, for example, a three-dimensional stacked phase change memory.

The bit states programmed in such non-volatile memories are generally stable and persistent over an extended period of time. However, in some non-volatile memories, the storage properties representing various bit states may be temporarily unstable for a relatively short duration of time following the programming operation until the storage properties stabilize. As a result, to avoid erroneous read operations, a period often referred to as a “lockout” period is imposed which prevents any read operations during the lockout period. Once the lockout period has expired, the storage properties are typically sufficiently stable to conduct accurate read operations of the bit state programmed into the bitcell.

In one aspect of the present description, the erratic or unpredictable nature of the storage properties in what is otherwise referred to as the “lockout period” following the programming of the bitcell in a bitcell programming interval, is advantageously utilized in a random number generation mode to read random numbers from the memory. It is recognized herein that the instability in the lockout interval is an inherent characteristic of bit state storage material used in fabrication of non-volatile memory bitcells such as crosspoint bitcells. This interval for reading random numbers follows the bitcell programming interval and is redesignated herein as a random bit state read interval. Accordingly, instead of locking out read operations in the interval following the bitcell programming interval, a read operation may be performed in a random bit state read interval to read a bit state of the bitcell, which bit state is random in nature.

Moreover, due to various factors including random distribution of inevitable fabrication process variations from bitcell to bitcell, no two bitcells are exactly the same. Since no two bitcells are exactly the same, the random bit state read from each bitcell may not be the same but may vary randomly from bitcell to bitcell. Still further, due to continuously changing factors such as the temperature or other environmental factors at which the read operation is conducted, the random bit state read from a particular bitcell may change in a random fashion from one random bit state read operation to the next random bit state read operation directed to the same bitcell. Other factors which change from random bit state read operation to the next random bit state read operation include the particular manner in which a bit state storage material changes from one state toward another state as a result of a programming operation. As a result, a high degree of randomness may be achieved. Furthermore due to the large number of bitcells available for use in random number generation, a high degree of entropy may be readily achieved as well.

As described below, in one embodiment, the random bit state read interval of the random number generation mode may be of the same duration and of the same timing following the bitcell programming interval, as the bitcell lockout interval of a read/write data storage mode. In other embodiments, the random bit state read interval of the random number generation mode may differ somewhat from the duration or timing but may substantially overlap the bitcell lockout interval of a read/write data storage mode.

A system employing random number generation with unstable bit states of non-volatile memory in accordance with an embodiment of the present disclosure may provide a hardware-efficient, and yet robust, and reliable on chip random bit generator for a variety of systems including a system on a chip (SoC). For example, the random number generator may utilize a portion of the same non-volatile memory used in a read/write data storage mode when not used in a random number generator mode.

It is appreciated that features and advantages of a system employing random number generation with unstable bit states of non-volatile memory in accordance with an embodiment of the present disclosure may vary, depending upon the particular application. In some embodiments, a random number generator in accordance with the present description may provide security at a reduced cost per bit due to savings resulting from utilizing bitcells already provided for read/write data storage.

Also, a random number generator in accordance with the present description utilizing non-volatile memory such as crosspoint memory, for example, can operate with relatively high speed and low latency. For example, crosspoint memory is generally substantially faster than many other non-volatile memory types such as flash memory based upon Not-And (NAND) bitcells. As a result, a random number generator in accordance with the present description utilizing crosspoint memory bitcells can provide a string of random bits at a high rate. Such performance may be difficult to economically match using analog circuitry which occupies significant hardware resources. In contrast, a random number generator in accordance with the present description can utilize memory bitcells that are otherwise used for read/write data storage operations.

Furthermore, crosspoint non-volatile memory bitcells may be stacked in multiple three-dimensional layers such that the foot print occupied by the memory may be substantially reduced as compared to non-stacked memory bitcells. Crosspoint memory bitcells may also be operated with substantially less power as compared to some other types of memory. For example, a crosspoint bitcell may utilize a Zener diode as a selector which can consume substantially less power as compared to a transistor switch type selector.

Still further, variations in fabrication processes employed for fabricating the bitcells of a random number generator in accordance with the present description, can add to the robustness and uniqueness of the random bits generated. Moreover, fabrication processes for crosspoint memory may employ additional processing operations including layer over layer deposition with a higher number of diffusion and Chemical Vapor Deposition (CVD) operations. These extra processing operations can introduce more bitcell to bitcell variations which in turn can contribute further to uniqueness of each bitcell and accordingly, a higher level of randomness. By comparison, analog random number generators are often adversely affected by fabrication process variations.

Although described herein in connection with bulk property change and phase change non-volatile memories, for example, it is believed that random number generation in accordance with the present description may be applied to other types of memory devices having an unstable storage property following programming. Such devices in accordance with embodiments described herein can be used either in stand-alone memory circuits or logic arrays, or can be embedded in microprocessors and/or digital signal processors (DSPs). Additionally, it is noted that although systems and processes are described herein primarily with reference to microprocessor based systems in the illustrative examples, it will be appreciated that in view of the disclosure herein, certain aspects, architectures, and principles of the disclosure are equally applicable to other types of device memory and logic devices.

In another aspect of the present description, various parameters of random number generation with unstable bit states of non-volatile memory in accordance with the present description may be programmable. For example, variables defining the timing placement or voltage magnitude of a read signal within a period of bit state instability may be programmed in registers or other programmable data structures.

The various parameters of random number generation with unstable bit states of non-volatile memory in accordance with the present description may programmed at the time of manufacture of the non-volatile memory controller or other device employing random number generation modes of non-volatile memory operation. For example values defining the voltage or placement of a read signal within a period of bit state instability may be selected by setting one or more hardware fuses on the device. Also, in some embodiments, system users and applications running on the system may be provided a capability of programming one or more parameters of random number in accordance with the present description in real time while the system is in use.

Implementations of the described techniques may include hardware, a method or process, or computer software on a computer-accessible medium. Thus, embodiments include corresponding computer systems, apparatus, and computer programs recorded on one or more computer storage devices, each configured to perform the actions of the methods.

A non-volatile memory interface employing random number generation with unstable bit states of non-volatile memory in accordance with the present description is described herein in connection with blocks of data. However, it is appreciated that a non-volatile memory interface in accordance with the present description may be applied to other units and subunits of data such as sectors, regions, volumes, tracks, segments, files, bytes, words, etc.

A non-volatile memory interface having random number generation in accordance with the present description may, in one embodiment, be employed in a system of one or more computers configured to perform particular operations or actions of random number generation, by virtue of having software, firmware, hardware, or a combination of them installed on the system that in operation causes or cause the system to perform the actions. One or more computer programs can be configured to perform particular operations or actions of random number generation with unstable bit states of non-volatile memory, by virtue of including instructions that, when executed by data processing apparatus, cause the apparatus to perform the actions.

Other embodiments include corresponding computer systems, apparatus, and computer programs recorded on one or more computer storage devices, each configured to perform the actions of the methods. Implementations of the described techniques may include hardware, a method or process, or computer software on a computer-accessible medium.

Thus, the operations described herein are performed by logic which is configured to perform the operations either automatically or substantially automatically with little or no system operator intervention, except where indicated as being performed manually such as user selection. Thus, as used herein, the term “automatic” includes both fully automatic, that is operations performed by one or more hardware or software controlled machines with no human intervention such as user inputs to a graphical user selection interface. As used herein, the term “automatic” further includes predominantly automatic, that is, most of the operations (such as greater than 50%, for example) are performed by one or more hardware or software controlled machines with no human intervention such as user inputs to a graphical user selection interface, and the remainder of the operations (less than 50%, for example) are performed manually, that is, the manual operations are performed by one or more hardware or software controlled machines with human intervention such as user inputs to a graphical user selection interface to direct the performance of the operations.

Many of the functional elements described in this specification have been labeled as “logic,” in order to more particularly emphasize their implementation independence. For example, a logic element may be implemented as a hardware circuit comprising custom Very Large Scale Integrated (VLSI) circuits or gate arrays, off-the-shelf semiconductors such as logic chips, transistors, or other discrete components. A logic element may also be implemented in programmable hardware devices such as field programmable gate arrays, programmable array logic, programmable logic devices or the like.

A logic element may also be implemented in software for execution by various types of processors. A logic element which includes executable code may, for instance, comprise one or more physical or logical blocks of computer instructions which may, for instance, be organized as an object, procedure, or function. Nevertheless, the executables of an identified logic element need not be physically located together, but may comprise disparate instructions stored in different locations which, when joined logically together, comprise the logic element and achieve the stated purpose for the logic element.

Indeed, executable code for a logic element may be a single instruction, or many instructions, and may even be distributed over several different code segments, among different programs, among different processors, and across several non-volatile memory devices. Similarly, operational data may be identified and illustrated herein within logic elements, and may be embodied in any suitable form and organized within any suitable type of data structure. The operational data may be collected as a single data set, or may be distributed over different locations including over different storage devices.

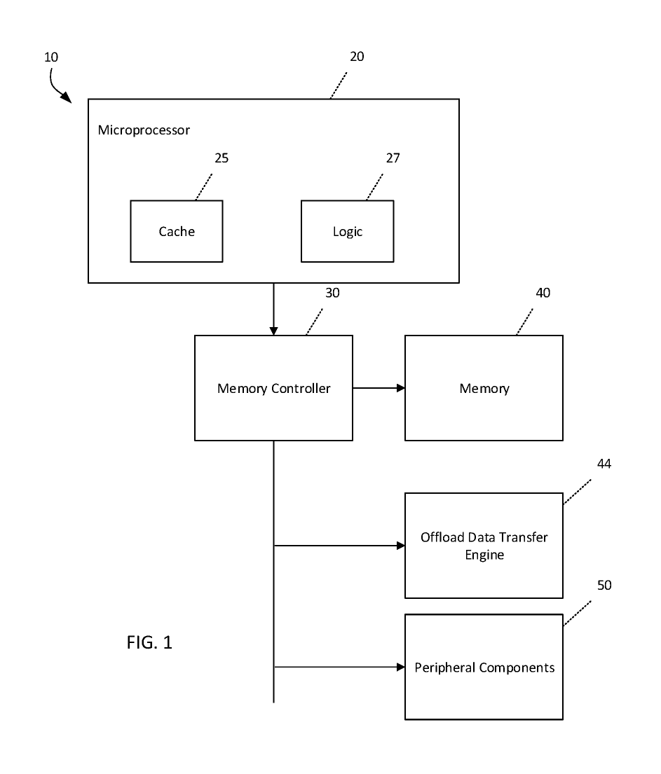

Turning to the figures, FIG. 1 is a high-level block diagram illustrating selected aspects of a system implemented, according to an embodiment of the present disclosure. System 10 may represent any of a number of electronic and/or computing devices, that may include a memory device. Such electronic and/or computing devices may include computing devices such as a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.) or component (e.g. system on a chip, processor, bridge, memory controller, memory, etc.). In alternative embodiments, system 10 may include more elements, fewer elements, and/or different elements. Moreover, although system 10 may be depicted as comprising separate elements, it will be appreciated that such elements may be integrated on to one platform, such as systems on a chip (SoCs). In the illustrative example, system 10 comprises a central processing unit or microprocessor 20, a memory controller 30, a memory 40 and peripheral components 50 which may include, for example, video controller, input device, output device, storage, network interface or adapter, battery, etc. In one embodiment, the peripheral components 50 may include a cryptographic engine or function logic configured to generate a random number cryptographic function in response to a read block of random bits. For example a fixed number of random bits generated by the random number generator may be used by the cryptographic engine as symmetric key bits or used as a random seed to generate a public/private key pair in a secure processor.

In another example, the peripheral components 50 may include for example, a universal integrated circuit card (UICC) comprising a subscriber identity module, which in some embodiments includes a secure storage to store secure user information. The peripheral components 50 may further include a security processor that may implement a trusted execution environment (TEE), and which may couple to application processor. Such an application or other processor may implement a secure mode of operation, such as Intel® Software Guard Extensions (SGX) to a given instruction set architecture, and circuitry for hosting of a TEE. A plurality of sensors including one or more multi-axis accelerometers and temperature sensors, for example, may couple to a processor to enable input of a variety of sensed information such as motion and other environmental information such as temperature information. In addition, one or more authentication devices of the peripheral components 50 may be used to receive, e.g., user biometric input for use in authentication operations.

The microprocessor 20 includes a cache 25 that may be part of a memory hierarchy to store instructions and data, and the system memory may include both volatile memory as well as the memory 40 depicted which may include a non-volatile memory. The system memory may also be part of the memory hierarchy. Logic 27 of the microprocessor 20 may include one or more cores, for example. Communication between the microprocessor 20 and the memory 40 may be facilitated by the memory controller (or chipset) 30, which may also facilitate in communicating with the peripheral components 50. The system may include an offload data transfer engine 44 for direct memory data transfers.

Storage of the peripheral components 50 may be, for example, non-volatile storage, such as solid-state drives magnetic disk drives, optical disk drives, a tape drive, flash memory, etc.). The storage may comprise an internal storage device or an attached or network accessible storage. The microprocessor 20 is configured to write data in and read data from the memory 40. Programs in the storage are loaded into the memory 40 and executed by the microprocessor 20. A network controller or adapter enables communication with a network, such as an Ethernet, a Fiber Channel Arbitrated Loop, etc. Further, the architecture may, in certain embodiments, include a video controller configured to render information on a display monitor, where the video controller may be embodied on a video card or integrated on integrated circuit components mounted on a motherboard or other substrate. An input device is used to provide user input to the microprocessor 20, and may include a keyboard, mouse, pen-stylus, microphone, touch sensitive display screen, input pins, sockets, or any other activation or input mechanism known in the art. An output device is capable of rendering information transmitted from the microprocessor 20, or other component, such as a display monitor, printer, storage, output pins, sockets, etc. The network adapter may be embodied on a network card, such as a peripheral component interconnect (PCI) card, PCI-express, or some other input/output (I/O) card, or on integrated circuit components mounted on a motherboard or other substrate.

One or more of the components of the device 10 may be omitted, depending upon the particular application. For example, a network router may lack a video controller, for example.

Any one or more of the devices of FIG. 1 including the cache 25, memory 40, system 10, memory controller 30 and peripheral components 50, may include a non-volatile memory employing random number generation in accordance with the present description, or be embodied as any type of data storage capable of storing data in a persistent manner (even if power is interrupted to non-volatile memory) such as but not limited to any combination of memory devices that use for example, chalcogenide phase change material (e.g., chalcogenide glass), 3-dimensional (3D) crosspoint memory, or other types of byte-addressable, write-in-place non-volatile memory, ferroelectric transistor random-access memory (FeTRAM), nanowire-based non-volatile memory, phase change memory (PCM), phase change memory with switch (PCMS), memory that incorporates memristor technology, magnetoresistive random-access memory (MRAM) or another spin transfer torque (STT)-MRAM as described above. Such memory elements in accordance with embodiments described herein can be used either in stand-alone memory circuits or logic arrays, or can be embedded in microprocessors and/or digital signal processors (DSPs). Additionally, it is noted that although systems and processes are described herein primarily with reference to microprocessor based systems in the illustrative examples, it will be appreciated that in view of the disclosure herein, certain aspects, architectures, and principles of the disclosure are equally applicable to other types of device memory and logic devices.

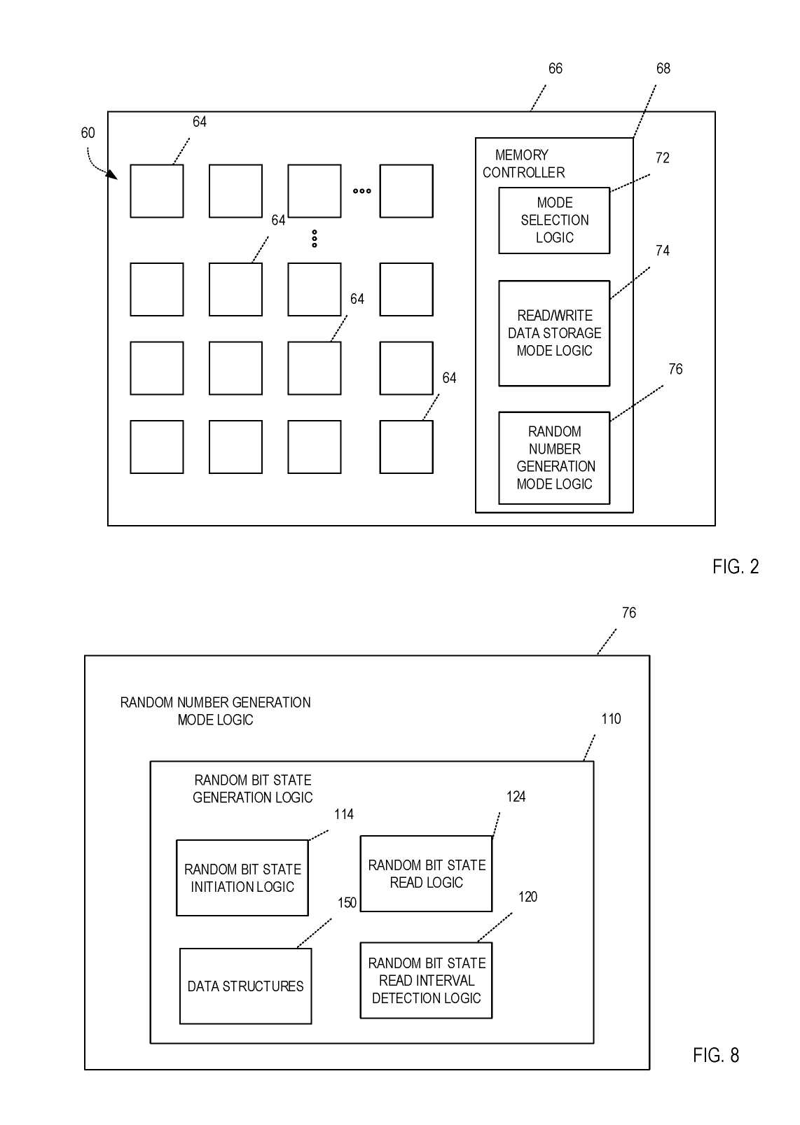

FIG. 2 shows an example of an array 60 of rows and columns of bitcells 64 of a memory 66 in accordance with one embodiment of the present description. The memory 66 which may be a non-volatile memory, for example, may also include a row or column decoders, a timer device and I/O devices (or I/O outputs). Bits of the same memory word may be separated from each other for efficient I/O design. A multiplexer (MUX) may be used to connect each column (or row) to the required circuitry during a Read command. Another MUX may be used to connect each column (or row) to a write driver during a write command or refresh operation if a read/write storage mode is implemented. A memory controller 68 performs random number generation operations in connection with the bitcells 64 of the memory 66. If the memory controller 68 is a multi-mode memory controller, it may also perform read commands, write commands, and refresh operations in a read/write data storage mode, for example.

In one embodiment, the memory controller 68 is fabricated in one or more integrated circuit devices separate from the devices of the memory 66. In other embodiments, the memory controller 68 and the memory 66 may be fabricated in a single integrated circuit device.

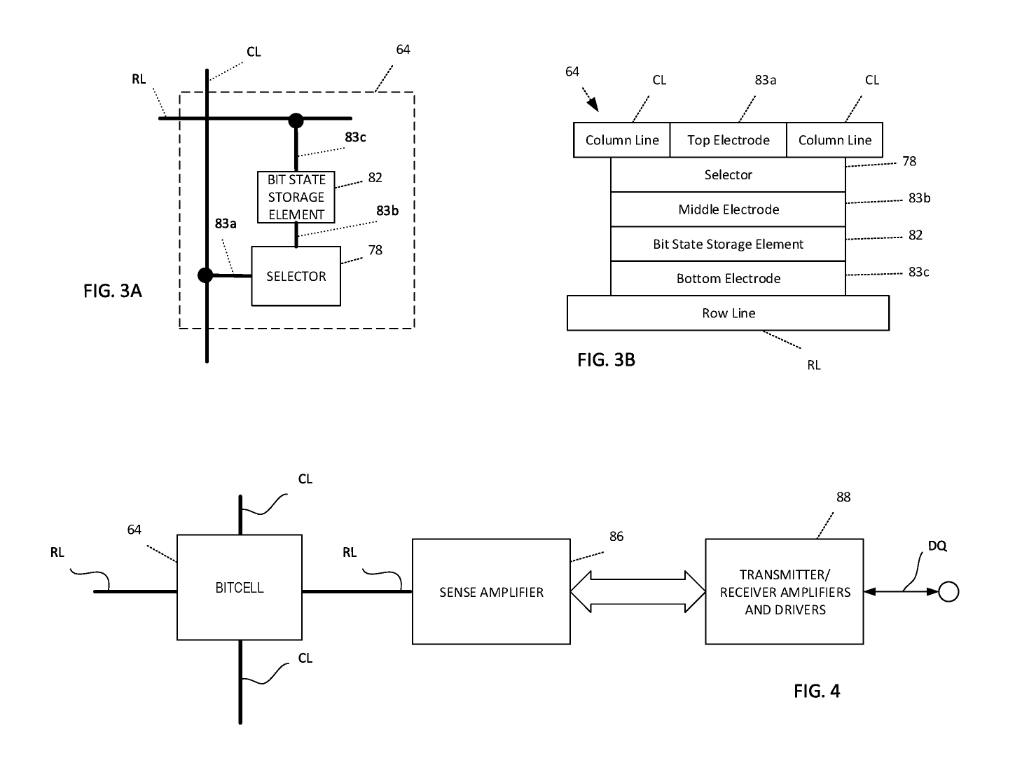

In the embodiment of FIGS. 2, 3A, 3B, each bitcell 64 includes a selector 78 (FIGS. 3A, 3B) and a bit state storage element 82 in which the storage element has a bit state storage material such as a chalcogenide material or other material having a storage property, the state of which represents a bit state of the bitcell 64. Thus, the bit state stored by the bitcell 64 is a function of a variable state of the storage property of the storage material. In a bulk property embodiment, a storage property of the storage material of the bit state storage element 82 is a bulk property of the storage material. By changing the state of the bulk property, different bit states may be stored in the storage element 82. In a phase change embodiment, the storage property is a phase such as crystalline or amorphous, of the storage material. By changing the phase of the storage material between crystalline and amorphous states, different bit states may be stored in the storage element 82. It is appreciated that a variety of storage properties and storage materials may be utilized in a storage element of a non-volatile memory in accordance with the present description, depending upon the particular application.

A bit state stored in a bitcell 64 may be sensed by sense amplifier circuitry 86 (FIG. 4) when an address line such as the column line CL, for example is made active by the memory controller 68 (FIG. 2) which activates the selector 78 (FIGS. 3A, 3B). In one embodiment, the read bit state is latched by the sense amplifier 86 as a function of a sensed voltage or current exhibited on a row line RL or in some embodiments on a column line CL. Thus, in one embodiment, the sense amplifier may be a differential amplifier which senses differences in voltages or currents and provides a corresponding output. Alternatively, the sense amplifier may be a nondifferential amplifier operating in a current mode. Other types of sense amplifiers may be utilized, depending upon the particular application.

In one embodiment, a bit state of a bitcell 64 may be read by checking a threshold voltage exhibited by a bit state storage material of the bitcell, which may provide an indirect measure of the resistance of bit state storage material. For example, to read the state of the bitcell 64, a demarcation voltage, V_{DM}, may be provided to bitcell 64 using column line CL and row line RL, and a resulting current flowing through the bitcell 64 may be compared against a threshold current using, for example, the sense amplifier 86. If V_{DM} is greater than the threshold voltage of the bitcell 64, a significant amount of current that is greater than the threshold current may flow through the bitcell 64, indicating that the bit state storage material is in a set state. If V_{DM} is less than the threshold voltage of the bitcell 64, the current flowing through the bitcell 64 may be much less than the threshold current, indicating that the bit state storage material is in a reset state. In an alternative embodiment, the demarcation voltage V_{DM} may be applied through a source resistance and the resulting voltage across the phase change state material may be sensed instead of the current.

An output of the sense amplifier circuitry 86 is amplified by amplifiers 88 having an input/output signal line labeled DQ in FIG. 4 in which the signal line DQ exhibits the sensed bit state of the bitcell 64 read in a read operation. Conversely, a write signal applied to the signal line DQ by a write operation stores a write bit state in the bitcell 64.

Examples of a bit state storage material may include a chalcogenide material or an ovonic material. An ovonic material may be a material that undergoes electronic or structural changes and acts as a semiconductor if subjected to application of a voltage potential, an electrical current, light, heat, etc. An ovonic material may be used in a memory element or in an electronic switch.

A chalcogenide material may be a material that includes at least one element from Group VI A of the periodic table. Group VI A of the periodic table includes elements such as sulfur (S), selenium (Se), and tellurium (Te). Phase change materials often also include elements from other groups of the periodic table, such as Group III A (gallium (Ga) and indium (In)), Group IV A (silicon (Si), germanium (Ge), and tin (Sn)), Group V A (phosphorus (P), arsenic (As), antimony (Sb), and bismuth (Bi)), Group I B (silver (Ag) and gold (Au)), and/or Group VIII B (cobalt (Co) and palladium (Pd)). Bit state storage material may be a chalcogenide element composition of the class of tellurium-germanium-antimony (TeₓGe_{y}Sb_{z}) material or a GeSbTe alloy, although various embodiments are not limited to just these.

The memory controller 68 (FIG. 2) includes a mode selection logic 72 configured to select various memory modes including a read/write data storage mode and a random number generation mode. However, it is appreciated that in other embodiments, the random number generation device in accordance with the present description may operate solely as a random number generation device such that other modes such as a read/write data storage mode may be eliminated.

In a multi-mode device, a read/write data storage mode logic 74 is configured to perform memory operations of the read/write data storage mode including, reading, writing, and storing bit states of each bitcell 64 of the memory 66. In one embodiment, the bit states of the bitcells 64 of the memory 66 are persistent for a duration of time which may be on the order of hours, days, weeks, months, years etc. depending upon the type of non-volatile memory. To prevent errors and loss in the read/write data storage mode, refresh circuitry of the read/write data storage mode logic 74 may be configured to periodically refresh the bit states stored in the bitcells if needed. The duration of time from one refresh cycle to the next may vary, depending upon the degree of persistence of the stored bit states of the bitcells of the memory 66.

In one aspect of the present description, the memory controller 68 further includes a random number generation mode logic 76 (FIG. 2) which is configured to perform operations of the random number generation mode including generating one or more random numbers. As described in greater detail below, a random number is generated by the random number generation mode logic 76 utilizing unstable bit states of some or all of the non-volatile bitcells of the memory 66 in accordance with an embodiment of the present disclosure.

In some embodiments, the random number generation mode may further include generating a cryptographic function based upon a generated random number. For example, a fixed number of generated random bits may be used by a cryptographic engine of the peripheral components 50 (FIG. 1) as symmetric key bits or may be used as a random seed to generate a public/private key pair in a secure processor. The memory controller 68 is configured to perform the described operations using appropriate hardware, software or firmware, or various combinations thereof.

The selector 78 (FIGS. 3A, 3B) of a bitcell 64 is configured to selectively isolate the bitcell from conducting current unless that bitcell has been selected to be read from or written to, that is, programmed. The selector 78 may include various devices such as a Zener diode, an ovonic device, or a switch transistor, depending upon the particular application. A bitcell may be selected for a read or programming write operation by providing suitable signals on a column line CL and a row line RL. Column line CL and/or row line RL may each be referred to as an address line, where a given pair of lines may be used to address the bitcell 64 during programming or reading. Column line CL and/or row line RL may also be referred to as a bit line and/or a word line, depending on whether or how column line CL and/or row line RL is used in accessing a specific bitcell or multiple different bitcells.

In one embodiment, as shown in FIG. 3B, a bitcell 64 may include a top electrode 83a coupled to a column line CL, a selector 78, a middle electrode 83b, a bit state storage element 82 which includes a bit state storage material to store a bit state representing a particular stored data value, and a bottom electrode 83c coupled to the row line RL. The aforementioned elements may be formed by successive layers between column line CL and row line RL or in other geometric relationships, depending on the embodiment. It is understood that bitcell 64 may not include all of the elements described and may include any of a variety of additional and/or alternative structures according to various embodiments as long as the structures individually or in combination provide bitcell 64 with an interval of unpredictable changing property characteristics such as, for example, threshold drift characteristics for providing a random bit state as described herein.

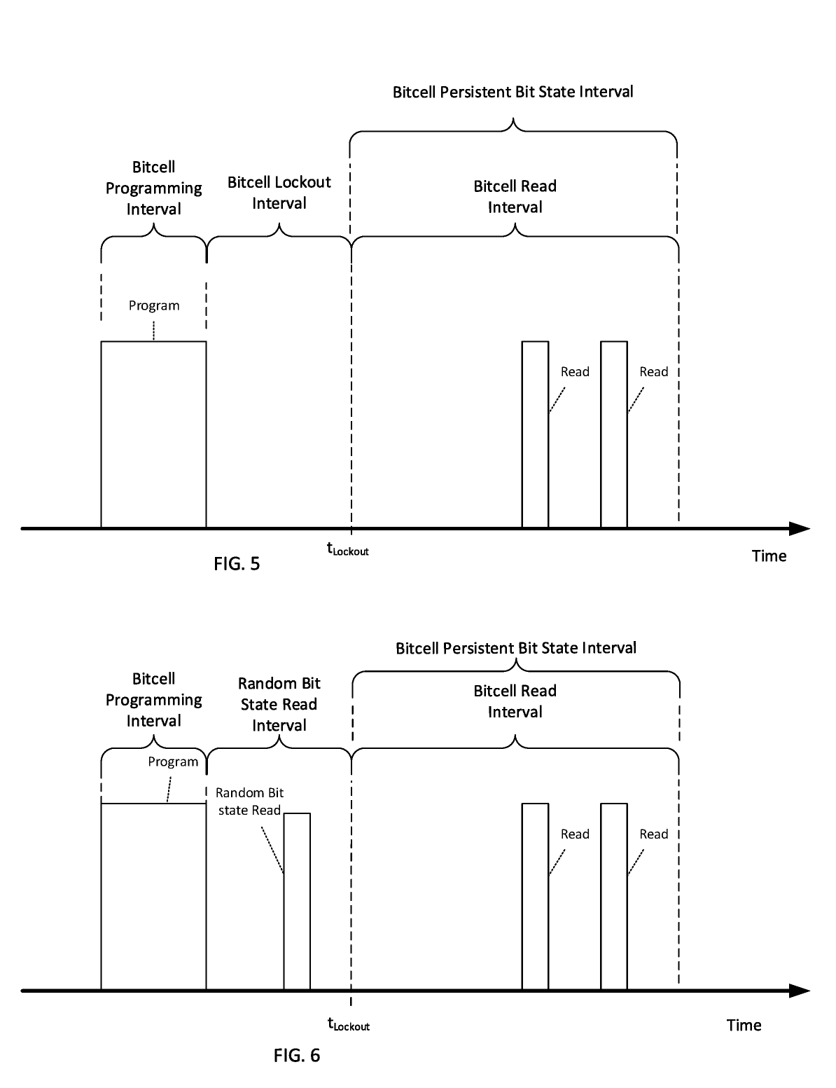

In the embodiment of FIG. 3, the bit state storage material of a bit state storage element 82 of a bitcell 64, is adapted to store one or more of at least two bit states, such as a set bit state and a reset bit state, as a function of a changeable or variable state of a storage property of the bit state storage material of the storage element 82. Thus, the bit state storage material may be a material having properties such as bulk, physical or electrical properties such as resistance, capacitance, phase, crystalline, amorphous or other characteristics, that may be programmed, that is, changed through the application of energy such as, for example, heat, light, voltage potential, or electrical current. FIG. 5 depicts an example of a bitcell being programmed by the application of suitable voltages or other energy to the bitcell in a bitcell programming interval. In this embodiment, the read/write data storage mode logic 74 (FIG. 2) has been configured to program each selected bitcell to have a selected bit state by the application of energy to the bit state storage material of the bit state storage element 82 (FIGS. 3A, 3B) of each selected bitcell.

A large variety of material types with widely differing properties may be selected for the bit state storage material. The bit state storage material may include a stoichiometric or a non-stoichiometric compound. The bit state storage material may include a eutectic or a peritectic material. The bit state storage material may include single-phase or multiphase materials. The bit state storage material may be doped with various elements. In various embodiments, the bit state storage material may have a binary composition, a ternary composition, or a quaternary composition or be composed of even more elements. In another embodiment, the bit state storage material may have a pseudo-binary composition. In some embodiments, phase change and bulk property memory cells may be made from chalcogenide materials.

Following programming of the bitcell in the bitcell programming interval, the state or states of the storage properties of the bit state storage material, are relatively unstable and unpredictable for an interval of time. The changing of storage properties over time is referred to herein as “drift.” The drift of storage properties following the programming of the bitcell in the bitcell programming interval can be particularly erratic and unpredictable. As a result, in the read/write data storage mode, a bitcell lockout interval is imposed in which bit state read operations are “locked out” to prevent erroneous read results due to unpredictable drift of storage properties of the bit state storage material. However, following the bitcell lockout interval, any drift of the storage properties of the bit state storage material is typically substantially less or is more predictable, or both. As a result, the state or states of the storage properties of the bit state storage material, and hence the programmed bit state (or states) may remain relatively stable in a bitcell persistent bit state interval of the read interval which follows the bitcell lockout interval depicted in FIG. 5. Because of the relative stability of the programmed bit state stored by the bit state storage material in the bitcell persistent bit state interval, the bit state programmed into the bitcell may be reliably read in the bitcell persistent bit state interval as depicted in FIG. 5.

In one aspect of the present description, the erratic or unpredictable nature of the drift of storage properties following the programming of the bitcell in the bitcell programming interval, is advantageously utilized in the random number generation mode to read random numbers from the memory. As shown in FIG. 6, this interval for reading random numbers in the random number generation mode follows the bitcell programming interval and is designated the random bit state read interval in FIG. 6. Accordingly, instead of locking out read operations in the interval following the bitcell programming interval, a read operation may be performed in a random bit state read interval in the random number generation mode to read a bit state of the bitcell, which bit state is random in nature. In the embodiments of FIGS. 5 and 6, the random bit state read interval of the random number generation mode of FIG. 6 may be of the same duration and of the same timing or placement which follow the bitcell programming interval, as that of the bitcell lockout interval of the read/write data storage mode of FIG. 5. It is appreciated that in other embodiments, one or more of the duration and timing of the random bit state read interval may differ from that of the bitcell lockout interval of a read/write data storage mode. As previously mentioned, some embodiments may lack a read/write data storage mode such that the memory or memory portion is used exclusively for random number generation.

In a bulk property change memory bitcell embodiment, the bit state storage material may remain relatively stable locally in the bitcell persistent bit state interval in one of two bulk property states or in a combination of the two bulk property states over an operating temperature range and exhibit different electrical or other properties in one bulk property state as compared to another bulk property state. In various embodiments, the bit state storage material may include bulk properties that can exist locally in a particular state without changing to another state for a prolonged period of time, such as for several years, for example, at room temperature, and can change rapidly to another state if, for example, the temperature is raised. The exact characteristics of the bit state storage material depend on the type of material and the bulk properties of the material that are used, but in some embodiments, the bit state storage material may be put into a high resistance state or a low resistance state, depending upon the state of a bulk property of the bit state storage material. The high resistance state may be referred to as the reset state and the low resistance state may be referred to as the set state, although in some embodiments the terminology may be reversed. In some embodiments, the high resistance state may be created by putting the bit state storage material into predominately high resistance bulk property state and the low resistance state may be created by putting at least a portion of the bit state storage material into a low resistance bulk property state. Other embodiments may create more than two logical states by using various combinations of the bulk property states to create different resistance ranges.

In a phase change memory bitcell embodiment, the bit state storage material may remain relatively stable locally in the bitcell persistent bit state interval in one of two or more phases or in a combination of phases over an operating temperature range and exhibit different electrical properties in the amorphous phase than in the crystalline phase. In various embodiments, the bit state storage material may include two properties: (a) it can exist locally in an amorphous phase without crystallization for a prolonged period of time, such as for several years, at room temperature, and (b) the amorphous phase can crystallize rapidly if temperature is raised. The exact characteristics of the bit state storage material depend on the type of material and the phases of the material that are used, but in some embodiments, the bit state storage material may be put into a high resistance state or a low resistance state. The high resistance state may be referred to as the reset state and the low resistance state may be referred to as the set state, although in some embodiments the terminology may be reversed. In some embodiments, the high resistance state may be created by putting the bit state storage material into a predominately amorphous phase and the low resistance state may be created by putting at least a portion of the bit state storage material into a crystalline phase. Other embodiments may create more than two logical states by using various combinations of the phases to create different resistance ranges.

It should also be noted that in some embodiments, the two states may not be characterized by a pure resistance but may be characterized by a change in a threshold voltage where a significant amount of current begins to flow. The state with a low threshold voltage may be referred to as the low resistance state and the state with a higher threshold voltage may be referred to as the high resistance state, even though either state may have a low resistance if the associated threshold voltage is exceeded. Accordingly, referring herein to changing the resistance may include changing a threshold voltage and references to a low or high resistance state may refer to a low or high voltage threshold, depending on the embodiment.

The bit state storage material may be programmed in a programming interval (FIGS. 5, 6) into one of at least two memory states by applying an electrical signal to bit state storage material to alter the state of a storage property of at least some of the bit state storage material. In a bulk property change bitcell embodiment, application of an electrical signal to a bit state storage material alters the state of the bulk property of at least some of the bit state storage material from one state to another state, thereby changing the bit state stored in the bitcell. In a phase change bitcell embodiment, the bit state storage material may be programmed into one of at least two memory states by applying an electrical signal to bit state storage material to alter the phase of at least some of the bit state storage material between a crystalline phase and an amorphous phase.

In one embodiment, programming of bit state storage material to alter the state of a storage property of the material may be accomplished by applying voltage potentials to middle electrode 83b (FIGS. 3A, 3B) and bottom electrode 83c, thereby generating a voltage potential across bit state storage material. An electrical current may flow through a portion of bit state storage material in response to the applied voltage potentials, and may result in heating of bit state storage material which may alter the state of a bulk property of the storage material, for example, or may alter the phase of at least some of the bit state storage material, for example and thereby alter the resistance or threshold voltage of the bit state storage material. The bit state storage material may also be referred to as a programmable resistive material in one embodiment or simply a programmable material in other embodiments.

In one embodiment, a voltage potential difference may be applied across a portion of bit state storage material by applying a potential difference between electrode 83b and electrode 83c. A current may flow through bit state storage material in response to the applied voltage potentials, and may result in heating of the bit state storage element 82. This heating and subsequent cooling may alter the memory state, such as the bulk property state or phase change state, for example, of the bit state storage element 82. Various resistances or threshold voltages of bit state storage material may be achieved to store information by varying the amount of current flow and duration through the volume of bit state storage element 82.

In general, in a phase change memory embodiment, a crystallization time of the bit state storage material decreases with increasing temperature. For example, if an amorphous bit state storage material of one embodiment is heated up to about 150 degrees Celsius (C), it may crystallize within a minute or so. If the embodiment of the amorphous bit state storage material is heated quickly up to about 200 C, it may crystallize within a second. If an embodiment of the amorphous bit state storage material is heated very quickly up to about 300 C, such as by a pulse, it may crystallize within a microsecond or even faster. For the bit state storage material, the crystalline phase is energetically more favorable (lower free energy) than the amorphous phase. But if a crystalline volume of the bit state storage material is then heated above the melting temperature of the bit state storage material, such as to a temperature greater than about 650 C, for example, and allowed to then cool quickly, the bit state storage material may revert to an amorphous phase.

In a set state, a portion of the bit state storage material may be in a crystalline or semi-crystalline state or at least a small filament of the bit state storage material may be conductive. In a reset state, at least a portion of bit state storage material may be in an amorphous or semi-amorphous state. The resistance of bit state storage material in the amorphous or semi-amorphous state may be greater than the resistance of bit state storage material in the crystalline or semi-crystalline state. It is to be appreciated that the association of reset and set with amorphous and crystalline states, respectively, is a convention and that at least an opposite convention may be adopted.

In one bulk property memory embodiment, a bit state storage material, if heated in the bitcell programming interval (FIG. 5) to a temperature above a bulk property transition temperature, may change state from a high resistance state to a state having a much lower resistance with a much lower voltage threshold to start the flow of current. This difference in states of the bulk properties of the bit state storage material may be used to create a bulk property memory device.

In a phase change memory embodiment, chalcogenide phase change material, if heated to a temperature above its glass transition temperature but below the melting point, will transform into a crystalline phase having a much lower resistance with a much lower voltage threshold to start the flow of current. This difference in the material properties between the amorphous and crystalline phases of chalcogenide materials may be used to create a phase change memory device.

Unlike other memory technologies that typically operate based on stored charge, operation of some embodiments of memory bitcells herein depends on bulk properties of the material used between word and bit lines. Write/read operation in a memory bitcell relies on: a) Vₛₑₜ and V_{Reset}, which are appropriate voltages for “Set” and “Reset” operations; b) V_{DM}, which is applied for reading the memory cell; and c) t, which is defined as the time at which a memory bitcell is read.

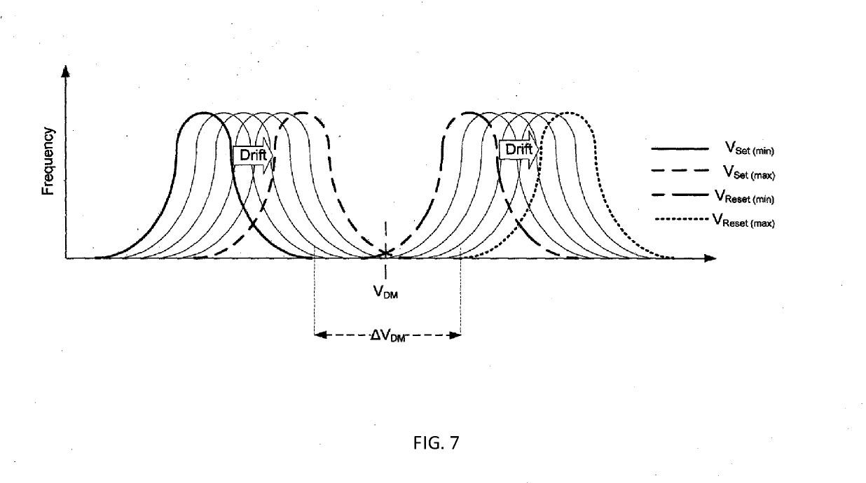

FIG. 7 is a graphical illustration of a probability distribution of voltages in accordance with an embodiment of the present description. In order to write into a memory bitcell (changing its internal state to a defined state of ‘1’ or ‘0’), a selected one of Vₛₑₜ and V_{Reset} (each of which may be within a given range between a maximum and a minimum) is applied across the bitcell for a certain time. Note that after Vₛₑₜ and V_{Reset} are disconnected from the bitcell, the memory bitcell experiences a drift between “Set” and “Reset” states (or vice versa) for a period of time, namely the lockout period. Accordingly, the threshold voltage exhibited by the bitcell drifts between “Set” and “Reset” states (or vice versa) during the lockout period. After the lockout period expires, the bitcell is stable and holds a defined written value. In a normal read operation, an appropriate demarcation voltage V_{DM} is applied across the bitcell after the bitcell exits from the lockout period. The corresponding current (I) to the applied V_{DM} is then sensed by a sense amplifier, and the written value of the accessed bitcell is read. In addition to t, V_{DM} is affected by a “Drift,” which is a cell-specific phenomenon occurring during the lockout period, as further shown in FIG. 7.

If a read operation is disturbed by a too early read time (a read time t<t_{Lockout} (FIG. 5)), and/or applying an irregular V_{DM}, an unstable bit value is captured to provide a random bit state. The conditions under which a random bit state can be extracted from a memory bitcell may be formulated as follows in one embodiment: a) t<t_{Lockout}; b) V_{DM (min)}<V_{DM} <V_{DM (max)}, where t_{Lockout} is typically in range of approximately a few microseconds. It is appreciated that the values of the read time t and the demarcation voltage V_{DM} for capturing a random bit state may vary, depending upon the particular application.

Thus, FIG. 7 depicts an example of a low resistance state of a bit state material representing a set bit state, in which the set bit state has an associated set state threshold voltage. FIG. 7 also depicts an example of a high resistance state of a bit state material representing a reset bit state, in which the reset bit state has an associated reset state threshold voltage.

To determine whether the bit state of the bit state storage element 82 is in a set bit state or a reset bit state, a demarcation voltage, V_{DM}, may be applied across the bit state storage element 82. In the read/write data storage mode, the demarcation voltage, V_{DM} is typically between the threshold voltages of the storage element in the set state and that of the reset state during the persistent bit state interval (FIG. 5). By applying V_{DM} across the bit state storage element 82, the bit state storage element 82 may conduct more current in one bit state than in the other bit state, allowing the bit state of the storage element to be read in a bitcell read interval (FIG. 5). Due to the persistent bit state of the bit state storage element, the bit state of the bit state storage element 82 may be repeatedly read in further read operations over the course of the bitcell read interval which may be quite long (on the order of days, weeks, months, or years, for example) depending upon the particular embodiment. In some embodiments, a refresh operation may be applied as needed to refresh the bit state of the bit state storage element.

As previously mentioned, storage properties of the bit state storage material of the bit state storage element 82 may change following the bitcell programming interval depicted in FIG. 5. Thus, the bit state storage element 82 may exhibit a drift in, for example, the bit states and hence the threshold voltages from their nominal values.

The drift of storage properties in the bitcell lockout interval (FIG. 5) following the programming of the bitcell in the bitcell programming interval can be particularly erratic and unpredictable. For example, the threshold voltages of the set bit state and reset bit state may have both drifted during the bitcell lockout interval following the programming interval such that demarcation voltage (V_{DM}) is no longer between the threshold voltages of the storage element in the set state and the reset state. Instead, in one example, the demarcation voltage (V_{DM}) is less than either of the threshold voltages of the storage element in the set state and the reset state. As a consequence, relatively little current may flow upon application of the demarcation voltage, indicating a high resistance state and a reset bit state regardless of the intended bit state programmed in the programming interval.

Conversely, threshold voltages of the set bit state and the reset bit state may have both drifted during the bitcell lockout interval following the programming interval such that demarcation voltage (V_{DM}) is greater than either of the threshold voltages of the storage element in the set state and the reset state. As a consequence, a relatively large amount of current may flow upon application of the demarcation voltage, indicating a low resistance state and a set bit state regardless of the intended bit state programmed in the programming interval.

It is noted that in such a scenario which the demarcation voltage (V_{DM}) may be greater than either of the threshold voltages of the storage element in the set state or reset state, may be destructive to data previously stored in the bitcell such that the content of the bitcell may change. Accordingly, in some embodiments, it may be appropriate to initiate random number generation with a programing write operation.

As a result, in the read/write data storage mode, the bitcell lockout interval is imposed in which bit state read operations are “locked out” to prevent erroneous read results due to unstable and unpredictable drift of storage properties of the bit state storage material. As previously mentioned, the memory read/write data storage mode logic 74 (FIG. 2) is configured to perform memory operations of the read/write data storage mode including, reading, writing, and storing bit states of each bitcell 64 of the memory 66. Accordingly, the memory read/write data storage mode logic 74 is configured to, in a read/write data storage mode, address a selected bitcell 64, program the selected bitcell 64 in a programming interval (FIG. 5), lockout memory operations such as read operations in a lockout interval, and read the programmed bit state in a read interval. The lockout interval of the read/write data storage mode may be configured as a fixed interval of time following the programming interval to provide sufficient time for the drift of the storage property of the bit state storage element to stabilize to a more stable, more predicable state of the bitcell persistent bit state interval as described above, following the lockout interval.

However, in one aspect of the present description, the erratic or unpredictable nature of the drift of storage properties in the previously described lockout interval following the programming of the bitcell in the bitcell programming interval, is advantageously utilized as a random bit state read interval (FIG. 6) in the random number generation mode to read random numbers from the memory. As shown in FIG. 6, this random bit state read interval for reading random numbers follows the bitcell programming interval in the same manner as the lockout interval of the read/write storage mode, but in the random number generation mode, it is designated the random bit state read interval in FIG. 6. Accordingly, instead of locking out read operations in the interval following the bitcell programming interval, in the random number generation mode, a read operation may be performed in a random bit state read interval to read a bit state of the bitcell, which bit state is random in nature. Thus, due to unpredictable drift of the storage property of the bit cell storage material of the bit cell storage element, the state of the storage property in the random bit state read interval may randomly have when read upon application of a demarcation voltage V_{DM}, a programmed bit state or may a high resistance bit state regardless of the programmed bit state or may have a low resistance bit state regardless of the programmed bit state.

The random number generation mode logic 76 (FIG. 2) is configured to perform operations of the random number generation mode including generating one or more random numbers. A random number is generated by the random number generation mode logic 76 utilizing the unpredictable drift of the storage property of the bit cell storage material of the bit cell storage element in the random bit state read interval by reading the random bit states in the random bit state read interval.

FIG. 8 shows one embodiment of the random number generation mode logic 76 which includes random bit state generation logic 110 configured to generate a random bit state in a bitcell. In one embodiment, the random bit state generation logic 110 (FIG. 8) of the memory controller is configured to select a block of bitcells 64 (FIG. 2) in which to generate a set of random bits. The number of bitcells in the selected block of bitcells may be of any suitable size, depending upon the number of random bits to be provided.

The random bit state generation logic 110 (FIG. 8) of the memory controller is further configured to determine whether the selected memory block is available for use in a random number generation mode. For example, the selected memory block may be unavailable due to active use in a read/write data storage mode in which data may be written to or read from the particular memory block or may be storing data which is to be retained.

Random bit state initiation logic 114 of the random bit state generation logic 110, is configured to initiate transition of a bit state of a bitcell from a first persistent bit state toward a second persistent bit state. However, instead of locking out memory operations such as verify or read operations in a bitcell lockout period (FIG. 5) of the read/write data storage mode, the random bit state generation logic 110 includes random bit state read interval detection logic 120 configured to detect a random bit state read interval in which a variable state of the storage property of the storage material is not stable but instead fluctuates in a substantially unpredictable manner. Random bit state read logic 124 of the random bit state generation logic 110 is configured to read a random bit state of the bitcell during a detected random bit state read interval to provide a bit having a random bit state before the transition to the new, programmed persistent bit state is completed.

In one embodiment, the transition is initiated by programming a bitcell in a bitcell programming interval toward exhibiting a particular programmed persistent bit state as described above in connection with the read/write data storage mode. Accordingly, the random bit state initiation logic 110 may be configured to initiate programming of a bitcell in a bitcell programming interval in a manner similar to that described above in connection with the read/write data storage mode. However, a random bit state is read from the programmed bitcell prior to the bit cell exhibiting the new persistent programmed bit state.

In the embodiments of FIGS. 5 and 6, the random bit state read interval detected by the random bit state read interval detection logic 120 of the random number generation mode of FIG. 6 may be of the same duration and of the same timing or placement following the bitcell programming interval, as the bitcell lockout interval of the read/write data storage mode of FIG. 5. Accordingly, in one embodiment, the random bit state read interval detection logic 120 may be configured to detect a random bit state read interval by timing an interval following a programming interval for a duration of time equal to that of the lockout interval of the read/write data storage mode. It is appreciated that in other embodiments, the duration and timing of the random bit state read interval may differ from that of the bitcell lockout interval of a read/write data storage mode. For example, the random bit state read interval may be set to have sufficient duration to facilitate obtaining random bit states in response to read operations conducted within the random bit state read interval. Conversely, the random bit state read interval may be set to have sufficiently short duration to facilitate repeating random bit generation operations for generating strings of random bits as described herein.

In one embodiment, the random bit state read logic 124 may be configured to read the random bit state of the bitcell at a fixed subinterval within the random bit state read interval. Because the exact bit cell storage properties of each bitcell may vary from bitcell to bitcell and may vary in a random manner due to fabrication process variations and other factors, a random bit state read from one bitcell during the random bit state read interval may differ from a random bit state read from another bitcell notwithstanding that both bitcells are read at the same time within a random bit state read interval. In another embodiment, the random bit state read logic 124 may be configured to read the random bit state of the bitcell at varying subintervals within the random bit state read interval. Thus, another degree of randomness may be added by, for example, randomly varying the time at which bitcells are read during the random bit cell read interval. Another degree of randomness may be added by, for example, randomly varying the demarcation voltage of random bit read operations.

Thus, the random bit state read logic 124 may include time generator logic and a voltage generator logic, which may randomly determine a corresponding read time and demarcation voltage for use in random number generation. Note that the read time may be an illegal read time (namely within the lockout period), while the demarcation voltage may be within a usual read mode range of demarcation voltages in one embodiment and may be outside the usual range in another embodiment.

Hence, the bit state storage element 82 may, as a result of various factors, randomly exhibit any bit state in the random bit state read interval independently of the bit state programmed into the storage element. As described above, one such factor in one embodiment is drift in which storage properties of a storage material of the bit state storage element of the bitcell change over time following programming of the bitcell. In one embodiment, the drift property depends on the bulk properties of the bit state storage material fabricated between the column CL line and the row line RL of the bit cell.

The bulk properties and hence the drift property are dependent upon among other factors, the random distribution of physical parameters introduced during the fabrication process. As a result, the exact drift properties of each bitcell may vary from bitcell to bitcell such that no two bitcells are identical and may vary in a random manner. Hence, a random bit state read from one bitcell during the random bit state read interval may differ from a random bit state read from another bitcell notwithstanding that many if not all factors are otherwise the same. Thus, the bit states read from a set of bitcells at the same time, and under the same environmental conditions, for example, may nonetheless produce a set of randomly distributed bit states read from the set of bitcells. Process variations in the fabrication processes of the bitcells on a die which may affect the drift characteristic differently in each bitcell include process variation parameters such as diffusion depth, layer thickness and other parameters of the bitcell fabrication process. Architectural variations which may affect the drift characteristic differently in each bitcell include for example, proximity of each individual bitcell to circuitry of the memory controller including encoder and decoder circuitry, and the location of each bitcell within the array of bitcells. These parameters cause the characteristics of bitcells to vary such that each bitcell behaves differently and produces a cell-specific readout value if they are read during the random bit state read interval.

Other factors which can contribute to the randomness of the bit states read from a bitcell in the random bit state read interval include the timing of the moment within the random bit state read interval in which the bit state is read as described above. Hence, a bit state read early in a random bit state read interval may differ from the bit state read from the same bitcell but read later at a different time within the random bit state read interval.

It is appreciated that achieving a random distribution of bit states is facilitated by operating the random number generator within normal environmental operating conditions such as temperature. If the degree of randomness is degraded by operating the random number generator out of normal operating conditions, logic and sensors may be provided to disable the random number generator should it be sensed that normal operating conditions such as operating temperature have been exceeded.

Various parameters of random number generation with unstable bit states of non-volatile memory in accordance with the present description may be programmable. For example, variables defining the duration and initiation of a random bit state read interval and variables defining placement or voltage of a read signal within a period of bit state instability may be programmed in registers or other programmable data structures 150 (FIG. 8).

The random bit state generation logic 110 may be further configured to test a set of random bits read from a selected memory block with a suitable quality test to ensure that the bit states are sufficiently random with sufficient degree of entropy. It is appreciated that a variety of quality tests for random number generation are suitable, depending upon the particular application.

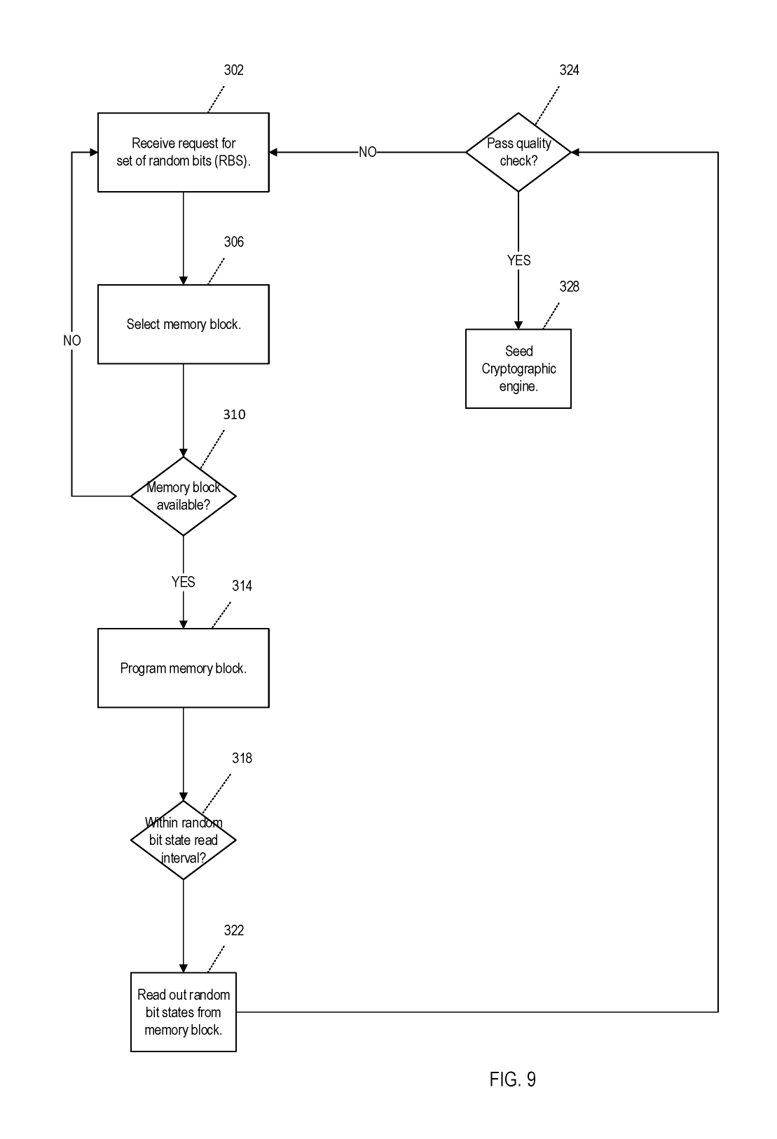

FIG. 9 depicts one example of operations of the memory controller 68 (FIG. 2) in generating a random number for use with a cryptographic engine. In response to a request (block 302) for a set of random bits (RBS) by an executing program or operating device of the computer system of FIG. 1, the random bit state generation logic 110 (FIG. 8) of the memory controller selects (block 306) a block of bitcells 64 (FIG. 2). The number of bitcells in the selected block of bitcells may be of any suitable size, depending upon the number of random bits to be provided in response to the requested set of random bits.

A determination (block 310) is made as to whether the selected memory block is available for use in a random number generation mode. For example, the selected memory block may be unavailable due to active use in a read/write data storage mode in which data may be written to or read from the particular memory block or may be storing data which is to be retained.

Upon determination (block 310) that a selected memory block is available for use in a random number generation mode, the selected memory block is programmed (block 314) by the random bit state initiation logic 114 (FIG. 8) by writing a suitable bit state or states into the bitcells of the selected memory block in a programming interval (FIG. 6). In one embodiment, all the bitcells of the selected memory block may be programmed at the same time in the same programming interval. In other embodiments, subportions of the selected memory block may be programmed in which all of the bitcells of the selected memory block subportion may be programmed at the same time in the same programming interval. The programming may be repeated for the remaining selected memory block subportions until all the subportions have been programmed.

The bit states programmed into the selected bitcells may in one embodiment all be the same such as all may be a set bit state or all may be a reset bit state. In another embodiment, the bit states programmed into the selected bitcells may form a pattern such as a checkerboard pattern or may represent a pseudo-random distribution over the selected block or block portion. Thus, in one example, the written data may correspond to an N-bit data value having predetermined value, e.g., approximately equal numbers of logic 0 and logic 1 values randomly distributed within the block. Other programming patterns may be utilized, depending upon the particular application.

Following the programming of the selected memory block or the programming of a selected memory block subportion in a programming interval, a determination (block 318) is made as to whether the bitcells which have been programmed are within a random bit state read interval (FIG. 6). As previously mentioned, the random bit state read interval detection logic 120 (FIG. 8) detects the random bit state read interval (FIG. 6) in which the bit states are sufficiently unpredictable notwithstanding the bit states programmed (block 314) into the selected memory block or block subportion, to return a random bit state from each such bitcell in response to a read operation conducted in the random bit state read interval (FIG. 6). Accordingly, within the random bit state interval (FIG. 6), random bit states are read (block 322) by the random bit state read logic 124 (FIG. 8) from the previously programmed (block 314) bitcells of the selected memory block or block subportion. Read operations continue for the remaining memory block subportions in which the read operations are directed to each the remaining selected memory block subportion in a random bit state interval following a programming interval, until all memory block subportions have been programmed (block 314) and the resultant random bits read (block 322) in a random bit read interval (block 318).

In one embodiment, the set of random bits read from the selected memory block may be tested (block 324) with a suitable quality test to ensure that the bit states are sufficiently random with a sufficient degree of entropy. It is appreciated that a variety of quality tests for random number generation are suitable, depending upon the particular application.

If the generated set of random bits passes (block 324) the quality test, the generated set of random bits may be used to seed (block 328) a cryptographic engine, for example. It is appreciated that a generated set of random bits may have other applications, depending upon the particular environment. Conversely, if the generated set of random bits does not pass (block 324) the quality test, another set of random bits may be generated as described above in connection with block 302-322.

The length of a string of logical ones and zeros of a set of generated random number memory bits produced by a memory 66 in the non-volatile memory cell random number generation mode may vary depending upon the particular application. For example, a string of generated random number memory bits received from the memory 66 in the non-volatile memory cell random number generation mode may be used to provide a cryptographic secure key or seed. In many applications, a degree of entropy provided by a 256 bit key, is useful. Accordingly, a string of random memory bits from a few to several Kilobytes (KB) in length is suitable for a number of cryptographic applications. It is appreciated that the random bit set or string length may vary, depending upon the particular application.

It is further appreciated that in some embodiments, one or more of the elements of the random bit state generation logic 110 (FIG. 8) and the cryptographic engine of the peripheral devices 50 (FIG. 1) may be eliminated. For example, in some random number generation device applications, it is sufficient to produce a string of random bits to be latched in suitable registers without further generation of ancillary functions such as cryptographic functions using the string of random bits for example.

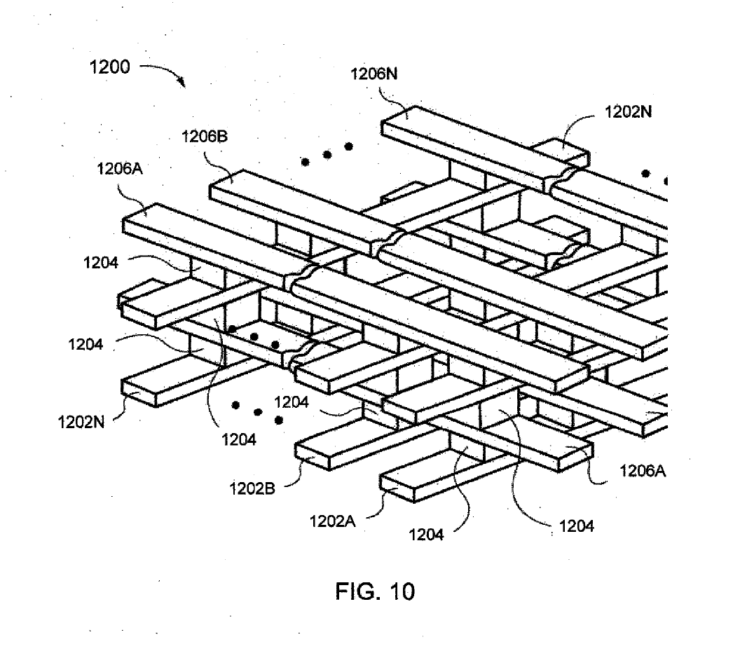

Referring now to FIG. 10, shown is a block diagram illustration of a memory cell in accordance with an embodiment of the present disclosure. In some examples, a memory array 1200 includes a first number of word lines 1202A, 1202B, . . . , 1202N (collectively referred to as word lines 1202) and a first number of bit lines 1206A, 1206B, . . . , 1206N (collectively referred to as bit lines 1206). As shown in FIG. 10, the word lines 1202 may be arranged parallel to one another. Bit lines 1206 can be arranged parallel to one another and orthogonal to word lines 1202. Word lines 1202 and bit lines 1206 can be made from a conductive material, such as copper, tungsten, titanium, aluminum, etc. Layers or decks of word lines and bit lines can be stacked to create a 3D lattice structure. As shown in FIG. 10, layers of word lines 1202 alternate with layers of bit lines 1206 to form a 3D structure. Memory array 1200 includes a plurality of memory bitcells 1204. In one embodiment, memory bitcells 1204 can be implemented as 3D crosspoint memory cells. Each memory bitcell 1204 is connected to a word line (e.g., word line 1202A) and a bit line (e.g., bit line 1206A). By connecting each memory cell to a single word line and a single bit line in a 3D cross-point array, each memory cell 1204 is individually accessible by specifying a word line and a bit line, for example, by a memory address.

It is seen from the above, that a system employing random number generation with unstable bit states of non-volatile memory in accordance with an embodiment of the present disclosure may provide a hardware-efficient, and yet robust, and reliable on chip random bit generator for a variety of systems including a system on a chip (SoC). In one embodiment, the random number generator may utilize a portion of the same non-volatile memory used in a read/write data storage mode when not used in a random number generator mode. Other aspects and advantages may be realized, depending upon the particular application.

### EXAMPLES

The following examples pertain to further embodiments.

Example 1 is an apparatus for use with a memory having a plurality of bitcells, each bitcell comprising a storage element having a bit state storage material having a storage property which represents a bit state of the bitcell as a function of a variable state of the storage property of the storage material. In one embodiment, the apparatus comprises random bit state generation logic configured to generate a random bit state in a bitcell, the random bit state generation logic including random bit state initiation logic configured to initiate transition of a bit state of a bitcell from a first persistent bit state to a second persistent bit state. The random bit state generation logic further includes random bit state read interval detection logic configured to detect a random bit state read interval in which the variable state of the storage property of the storage material is unstable and fluctuates in a substantially unpredictable manner, and random bit state reading logic configured to read the bit state of the bitcell during a detected random bit state read interval to provide a bit having a random bit state.

In Example 2, the subject matter of Examples 1-9 (excluding the present Example) can optionally include wherein the random bit state reading logic is further configured to read the bit states of a block of bitcells during a random bit state read interval of each bitcell to read a block of random bits wherein each bitcell of the block of bitcells provides a bit having a random bit state.

In Example 3, the subject matter of Examples 1-9 (excluding the present Example) can optionally include wherein each bitcell is fabricated in a fabrication process and wherein the random bit state of each bitcell is a function of fabrication process variations in the fabrication of the bitcells.

In Example 4, the subject matter of Examples 1-9 (excluding the present Example) can optionally include wherein the random bit state of a particular bitcell is a function of threshold voltage drift of the storage material of the particular bitcell. In addition, the threshold voltage drift of the storage material of the particular bitcell is a function of bulk properties of the storage material of the particular bitcell wherein bulk properties of the storage material of the particular bitcell are a function of fabrication process variations in the fabrication of the particular bitcell.

In Example 5, the subject matter of Examples 1-9 (excluding the present Example) can optionally include wherein the fabrication process variations include at least one of diffusion depth and layer thickness of a material of each bitcell.

In Example 6, the subject matter of Examples 1-9 (excluding the present Example) can optionally include a memory controller for the memory wherein the controller has components, and the plurality of bitcells is arranged in an array of bitcells. In one embodiment, the random bit state of a particular bitcell of the array of bitcells is a function of at least one of position of the particular bitcell within the array of bitcells and proximity of the particular bitcell to components of the controller.

In Example 7, the subject matter of Examples 1-9 (excluding the present Example) can optionally include wherein the random bit state initiation logic is further configured to program in a programming interval, one of a set state and a reset state in a bitcell wherein the random bit state read interval follows the programming interval.

In Example 8, the subject matter of Examples 1-9 (excluding the present Example) can optionally include cryptographic function logic configured to generate a random number cryptographic function in response to the read block of random bits.

In Example 9, the subject matter of Examples 1-9 (excluding the present Example) can optionally include a system, the system comprising a central processing unit, and a memory having a plurality of bitcells. Each bitcell comprises a storage element having a bit state storage material having a storage property which represents a bit state of the bitcell as a function of a variable state of the storage property of the storage material. The system further comprises a memory controller having the random bit state generation logic, and at least one of: a display communicatively coupled to the processor, a network interface communicatively coupled to the central processing unit, and a battery coupled to provide power to the system.

Example 10 is a system, comprising a central processing unit, and a random number generation device which includes a memory having a plurality of bitcells, each bitcell comprising a storage element having a bit state storage material having a storage property which represents a bit state of the bitcell as a function of a variable state of the storage property of the storage material. In one embodiment, the random number generation device further includes a controller having random bit state generation logic configured to generate a random bit state in a bitcell, in which the random bit state generation logic includes random bit state initiation logic configured to initiate transition of a bit state of a bitcell from a first persistent bit state to a second persistent bit state. In one embodiment, the random bit state generation logic further includes random bit state read interval detection logic configured to detect a random bit state read interval in which the variable state of the storage property of the storage material is unstable and fluctuates in a substantially unpredictable manner, and random bit state reading logic configured to read the bit state of the bitcell during a detected random bit state read interval to provide a bit having a random bit state.

In Example 11, the subject matter of Examples 10-17 (excluding the present Example) can optionally include wherein the random bit state reading logic is further configured to read the bit states of a block of bitcells during a random bit state read interval of each bitcell to read a block of random bits wherein each bitcell of the block of bitcells provides a bit having a random bit state.

In Example 12, the subject matter of Examples 10-17 (excluding the present Example) can optionally include wherein each bitcell is fabricated in a fabrication process and wherein the random bit state of each bitcell is a function of fabrication process variations in the fabrication of the bitcells.

In Example 13, the subject matter of Examples 10-17 (excluding the present Example) can optionally include wherein the random bit state of a particular bitcell is a function of threshold voltage drift of the storage material of the of the particular bitcell. In one embodiment, the threshold voltage drift of the storage material of the particular bitcell is a function of bulk properties of the storage material of the particular bitcell and wherein bulk properties of the storage material of the particular bitcell are a function of fabrication process variations in the fabrication of the particular bitcell.

In Example 14, the subject matter of Examples 10-17 (excluding the present Example) can optionally include wherein the fabrication process variations include at least one of diffusion depth and layer thickness of a material of each bitcell.

In Example 15, the subject matter of Examples 10-17 (excluding the present Example) can optionally include wherein the controller has components, the plurality of bitcells is arranged in an array of bitcells. In one embodiment, the random bit state of a particular bitcell of the array of bitcells is a function of at least one of position of the particular bitcell within the array of bitcells and proximity of the particular bitcell to components of the controller.

In Example 16, the subject matter of Examples 10-17 (excluding the present Example) can optionally include wherein the random bit state initiation logic is further configured to program in a programming interval, one of a set state and a reset state in a bitcell wherein the random bit state read interval follows the programming interval and precedes a persistent bit state interval.

In Example 17, the subject matter of Examples 10-17 (excluding the present Example) can optionally include cryptographic function logic configured to generate a random number cryptographic function in response to the read block of random bits.

Example 18 is a method, comprising initiating transition of a bit state of a bitcell from a first persistent bit state to a second persistent bit state through a random bit state read interval in which the bit state of the bitcell is a function of a variable state of a storage property of a storage material of a storage element of the bitcell and wherein the variable state of the storage property of the storage material fluctuates in an indeterminate manner in the random bit state read interval. In one embodiment, the method further includes reading a bit state of the bitcell during the random bit state read interval to provide a bit having a random bit state.

In Example 19, the subject matter of Examples 18-25 (excluding the present Example) can optionally include wherein the bit state reading includes reading the bit states of a block of bitcells during a random bit state read interval of each bitcell of the block of bitcells to read a block of random bits wherein each bitcell of the block of bitcells provides a bit having a random bit state.

In Example 20, the subject matter of Examples 18-25 (excluding the present Example) can optionally include wherein a random bit state of a bit read from a particular bitcell is a function of fabrication process variations in the fabrication of the particular bitcell.

In Example 21, the subject matter of Examples 18-25 (excluding the present Example) can optionally include wherein a random bit state of the particular bitcell is a function of threshold voltage drift of the storage material of the storage element of the particular bitcell and wherein the threshold voltage drift of the storage material of the storage element is a function of bulk properties of the storage material of the storage element of the particular bitcell. In one embodiment, the bulk properties of the storage material of the particular bitcell are a function of fabrication process variations in the fabrication of the particular bitcell.

In Example 22, the subject matter of Examples 18-25 (excluding the present Example) can optionally include wherein the fabrication process variations include at least one of diffusion depth and layer thickness of a material of the particular bitcell.

In Example 23, the subject matter of Examples 18-25 (excluding the present Example) can optionally include wherein the random bit state of a particular bitcell is a function of at least one of position of the particular bitcell within an array of bitcells and proximity of the particular bitcell to components of a memory controller.

In Example 24 the subject matter of Examples 18-25 (excluding the present Example) can optionally include wherein initiating transition of a bit state of a bitcell from a first persistent bit state to a second persistent bit state includes programming in a programming interval, one of a set state and a reset state in the bitcell. In one embodiment, the random bit state read interval follows the programming interval and precedes a persistent bit state interval.

In Example 25, the subject matter of Examples 18-25 (excluding the present Example) can optionally include generating a random number cryptographic function in response to the read block of random bits.

Example 26 is an apparatus comprising means to perform a method as claimed in any preceding claim.

Example 27 is an apparatus for use with a memory having a plurality of bitcells, each bitcell comprising a storage element having a bit state storage material having a storage property which represents a bit state of the bitcell as a function of a variable state of the storage property of the storage material, the apparatus comprising random bit state generation logic means configured for generating a random bit state in a bitcell, and the random bit state generation logic means including random bit state initiation logic means configured for initiating transition of a bit state of a bitcell from a first persistent bit state to a second persistent bit state. In one embodiment, the random bit state generation logic means further includes random bit state read interval detection logic means configured for detecting a random bit state read interval in which the variable state of the storage property of the storage material is unstable and fluctuates in a substantially unpredictable manner, and random bit state reading logic means configured for reading the bit state of the bitcell during a detected random bit state read interval to provide a bit having a random bit state.

In Example 28, the subject matter of Examples 27-34 (excluding the present Example) can optionally include wherein the random bit state reading logic means is further configured for reading the bit states of a block of bitcells during a random bit state read interval of each bitcell to read a block of random bits wherein each bitcell of the block of bitcells provides a bit having a random bit state.

In Example 29, the subject matter of Examples 27-34 (excluding the present Example) can optionally include wherein each bitcell is fabricated in a fabrication process and wherein the random bit state of each bitcell is a function of fabrication process variations in the fabrication of the bitcells.

In Example 30, the subject matter of Examples 27-34 (excluding the present Example) can optionally include wherein the random bit state of a particular bitcell is a function of threshold voltage drift of the storage material of the particular bitcell and wherein the threshold voltage drift of the storage material of the particular bitcell is a function of bulk properties of the storage material of the particular bitcell. In one embodiment, bulk properties of the storage material of the particular bitcell are a function of fabrication process variations in the fabrication of the particular bitcell.

In Example 31, the subject matter of Examples 27-34 (excluding the present Example) can optionally include wherein the fabrication process variations include at least one of diffusion depth and layer thickness of a material of each bitcell.

In Example 32, the subject matter of Examples 27-34 (excluding the present Example) can optionally include a memory controller for the memory wherein the controller has components, the plurality of bitcells is arranged in an array of bitcells, and wherein the random bit state of a particular bitcell of the array of bitcells is a function of at least one of position of the particular bitcell within the array of bitcells and proximity of the particular bitcell to components of the controller.

In Example 33, the subject matter of Examples 27-34 (excluding the present Example) can optionally include wherein the random bit state initiation logic means is further configured for programming in a programming interval, one of a set state and a reset state in a bitcell wherein the random bit state read interval follows the programming interval.

In Example 34, the subject matter of Examples 27-34 (excluding the present Example) can optionally include cryptographic function logic means configured for generating a random number cryptographic function in response to the read block of random bits.

Example 35 is a computer program product for a computing system wherein the computer program product comprises a computer readable storage medium having program instructions embodied therewith, the program instructions executable by a processor of the computing system to cause operations, the operations comprising initiating transition of a bit state of a bitcell from a first persistent bit state to a second persistent bit state through a random bit state read interval in which the bit state of the bitcell is a function of a variable state of a storage property of a storage material of a storage element of the bitcell and wherein the variable state of the storage property of the storage material fluctuates in an indeterminate manner in the random bit state read interval. In one embodiment, the operations further comprise reading a bit state of the bitcell during the random bit state read interval to provide a bit having a random bit state.

In Example 36, the subject matter of Examples 35-42 (excluding the present Example) can optionally include wherein the bit state reading includes reading the bit states of a block of bitcells during a random bit state read interval of each bitcell of the block of bitcells to read a block of random bits wherein each bitcell of the block of bitcells provides a bit having a random bit state.

In Example 37, the subject matter of Examples 35-42 (excluding the present Example) can optionally include wherein a random bit state of a bit read from a particular bitcell is a function of fabrication process variations in the fabrication of the particular bitcell.

In Example 38, the subject matter of Examples 35-42 (excluding the present Example) can optionally include wherein a random bit state of the particular bitcell is a function of threshold voltage drift of the storage material of the storage element of the particular bitcell and wherein the threshold voltage drift of the storage material of the storage element is a function of bulk properties of the storage material of the storage element of the particular bitcell. In one embodiment, bulk properties of the storage material of the particular bitcell are a function of fabrication process variations in the fabrication of the particular bitcell.

In Example 39, the subject matter of Examples 35-42 (excluding the present Example) can optionally include wherein the fabrication process variations include at least one of diffusion depth and layer thickness of a material of the particular bitcell.

In Example 40, the subject matter of Examples 35-42 (excluding the present Example) can optionally include wherein the random bit state of a particular bitcell is a function of at least one of position of the particular bitcell within an array of bitcells and proximity of the particular bitcell to components of a memory controller.

In Example 41, the subject matter of Examples 35-42 (excluding the present Example) can optionally include wherein initiating transition of a bit state of a bitcell from a first persistent bit state to a second persistent bit state includes programming in a programming interval, one of a set state and a reset state in the bitcell wherein the random bit state read interval follows the programming interval and precedes a persistent bit state interval.

In Example 42, the subject matter of Examples 35-42 (excluding the present Example) can optionally include wherein the operations further comprise generating a random number cryptographic function in response to the read block of random bits.

In Example 43, the subject matter of Examples 1-42 can optionally include wherein the memory is a non-volatile memory.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. An apparatus comprising:
a memory having a plurality of bitcells, each bitcell comprising a storage element having a bit state storage material having a storage property which represents a bit state of the bitcell as a function of a variable state of the storage property of the storage material; and
a memory controller for the memory, the memory controller including:
random bit state generation logic configured to generate a random bit state in a bitcell, the random bit state generation logic including:
random bit state initiation logic configured to initiate transition of a bit state of a bitcell from a first persistent bit state to a second persistent bit state;
random bit state read interval detection logic configured to detect a random bit state read interval in which the variable state of the storage property of the storage material is unstable and fluctuates in a substantially unpredictable manner; and
random bit state reading logic configured to read the bit state of the bitcell during a detected random bit state read interval to provide a bit having a random bit state.

2. The apparatus of claim 1 wherein the random bit state reading logic is further configured to read the bit states of a block of bitcells during a random bit state read interval of each bitcell to read a block of random bits wherein each bitcell of the block of bitcells provides a bit having a random bit state.

3. The apparatus of claim 2 wherein each bitcell is fabricated in a fabrication process and wherein the random bit state of each bitcell is a function of fabrication process variations in the fabrication of the bitcells.

4. The apparatus of claim 3 wherein the random bit state of a particular bitcell is a function of threshold voltage drift of the storage material of the particular bitcell and wherein the threshold voltage drift of the storage material of the particular bitcell is a function of bulk properties of the storage material of the particular bitcell and wherein bulk properties of the storage material of the particular bitcell are a function of fabrication process variations in the fabrication of the particular bitcell.

5. The apparatus of claim 3 wherein the fabrication process variations include at least one of diffusion depth and layer thickness of a material of each bitcell.

6. The apparatus of claim 2 wherein the memory controller has components, the plurality of bitcells is arranged in an array of bitcells, and wherein the random bit state of a particular bitcell of the array of bitcells is a function of at least one of position of the particular bitcell within the array of bitcells and proximity of the particular bitcell to components of the memory controller.

7. The apparatus of claim 1 wherein the random bit state initiation logic is further configured to program in a programming interval, one of a set state and a reset state in a bitcell wherein the random bit state read interval follows the programming interval.

8. The apparatus of claim 2 further comprising cryptographic function logic configured to generate a random number cryptographic function in response to the read block of random bits.

9. The apparatus of claim 1 wherein the memory is a non-volatile memory.

10. A system, comprising:
a central processing unit; and
a random number generation device including:
a memory having a plurality of bitcells, each bitcell comprising a storage element having a bit state storage material having a storage property which represents a bit state of the bitcell as a function of a variable state of the storage property of the storage material; and
a controller having random bit state generation logic configured to generate a random bit state in a bitcell, the random bit state generation logic including:
random bit state initiation logic configured to initiate transition of a bit state of a bitcell from a first persistent bit state to a second persistent bit state;
random bit state read interval detection logic configured to detect a random bit state read interval in which the variable state of the storage property of the storage material is unstable and fluctuates in a substantially unpredictable manner; and
random bit state reading logic configured to read the bit state of the bitcell during a detected random bit state read interval to provide a bit having a random bit state.

11. The system of claim 10 wherein the random bit state reading logic is further configured to read the bit states of a block of bitcells during a random bit state read interval of each bitcell to read a block of random bits wherein each bitcell of the block of bitcells provides a bit having a random bit state.

12. The system of claim 11 wherein each bitcell is fabricated in a fabrication process and wherein the random bit state of each bitcell is a function of fabrication process variations in the fabrication of the bitcells.

13. The system of claim 12 wherein the random bit state of a particular bitcell is a function of threshold voltage drift of the storage material of the of the particular bitcell and wherein the threshold voltage drift of the storage material of the particular bitcell is a function of bulk properties of the storage material of the particular bitcell and wherein bulk properties of the storage material of the particular bitcell are a function of fabrication process variations in the fabrication of the particular bitcell.

14. The system of claim 12 wherein the fabrication process variations include at least one of diffusion depth and layer thickness of a material of each bitcell.

15. The system of claim 11 wherein the controller has components, the plurality of bitcells is arranged in an array of bitcells, and wherein the random bit state of a particular bitcell of the array of bitcells is a function of at least one of position of the particular bitcell within the array of bitcells and proximity of the particular bitcell to components of the controller.

16. The system of claim 10 wherein the random bit state initiation logic is further configured to program in a programming interval, one of a set state and a reset state in a bitcell wherein the random bit state read interval follows the programming interval and precedes a persistent bit state interval.

17. The system of claim 11 further comprising cryptographic function logic configured to generate a random number cryptographic function in response to the read block of random bits.

18. The apparatus of claim 9 wherein the memory is a non-volatile memory.

19. A method, comprising:
initiating transition of a bit state of a bitcell from a first persistent bit state to a second persistent bit state through a random bit state read interval in which the bit state of the bitcell is a function of a variable state of a storage property of a storage material of a storage element of the bitcell and wherein the variable state of the storage property of the storage material fluctuates in an indeterminate manner in the random bit state read interval; and
reading a bit state of the bitcell during the random bit state read interval to provide a bit having a random bit state.

20. The method of claim 19 wherein the bit state reading includes reading the bit states of a block of bitcells during a random bit state read interval of each bitcell of the block of bitcells to read a block of random bits wherein each bitcell of the block of bitcells provides a bit having a random bit state.

21. The method of claim 20 wherein a random bit state of a bit read from a particular bitcell is a function of fabrication process variations in the fabrication of the particular bitcell.

22. The method of claim 21 wherein a random bit state of the particular bitcell is a function of threshold voltage drift of the storage material of the storage element of the particular bitcell and wherein the threshold voltage drift of the storage material of the storage element is a function of bulk properties of the storage material of the storage element of the particular bitcell and wherein bulk properties of the storage material of the particular bitcell are a function of fabrication process variations in the fabrication of the particular bitcell.

23. The method of claim 21 wherein the fabrication process variations include at least one of diffusion depth and layer thickness of a material of the particular bitcell.

24. The method of claim 20 wherein the random bit state of a particular bitcell is a function of at least one of position of the particular bitcell within an array of bitcells and proximity of the particular bitcell to components of a memory controller.

25. The method of claim 19 wherein initiating transition of a bit state of a bitcell from a first persistent bit state to a second persistent bit state includes programming in a programming interval, one of a set state and a reset state in the bitcell wherein the random bit state read interval follows the programming interval and precedes a persistent bit state interval.

26. The method of claim 20 further comprising generating a random number cryptographic function in response to the read block of random bits.
